(19) United States
(12) Patent Application Publication
(10) Pub. No.: US 2026/0159164 A1
(43) Pub. Date: Jun. 11, 2026

(54) SUSPENSION MEMBER

(71) Applicant: TOYOTA JIDOSHA KABUSHIKI KAISHA, Toyota-shi (JP)

(72) Inventor: Takahiro ITO, Toyota-shi (JP)

(73) Assignee: TOYOTA JIDOSHA KABUSHIKI KAISHA, Toyota-shi (JP)

(21) Appl. No.: 19/379,707

(22) Filed: Nov. 4, 2025

(30) Foreign Application Priority Data
Dec. 11, 2024 (JP) 2024-216980

(51) Int. Cl. B62D 21/02

(52) U.S. Cl. CPC B62D 21/02

(57) ABSTRACT

The suspension member includes a part of the skeletal member, and a pair of member portions having substantially L-shaped cutout open cross-sectional shapes. The member portions are disposed such that, when viewed from one direction, the substantially L-shaped cutout open cross-sectional shapes are combined to face each other to define a closed cross-sectional shape.

### CROSS-REFERENCE TO RELATED APPLICATION

This application claims priority to Japanese Patent Application No. 2024-216980 filed on December 11, 2024. The disclosure of the above-identified application, including the specification, drawings, and claims, is incorporated by reference herein in its entirety.

### BACKGROUND

1. Technical Field

The present disclosure relates to a suspension member.

2. Description of Related Art

The following Japanese Unexamined Patent Application Publication No. 2012-041009 (JP 2012-041009 A) discloses a configuration of a suspension member on which a motor is mounted. In a suspension member of the related art, a skeletal member that constitutes the suspension member has a closed cross-sectional shape.

### SUMMARY

However, in the vicinity of the suspension member, a motor, various pieces of vehicle equipment, and the like are disposed, so that a space for disposing the motor is reduced. Therefore, realizing the skeletal member as a closed cross-sectional shape as in the related art is difficult, and there is room for improvement in the structure of the suspension member.

The present disclosure has been made in view of the above circumstances, and an object of the present disclosure is to provide a suspension member that can ensure rigidity and achieve space saving.

A suspension member according to a first aspect of the present disclosure includes a pair of member portions. The member portions constitute a part of a skeletal member and each have a substantially L-shaped open cross-sectional shape. The member portions are disposed such that, as viewed in one direction, the substantially L-shaped open cross-sectional shapes, when the member portions are taken in combination, face each other and define a closed cross-sectional shape.

In the suspension member according to the first aspect of the present disclosure, the member portions are disposed such that, as viewed in one direction, the substantially L-shaped open cross-sectional shapes, when the member portions are taken in combination, face each other and define a closed cross-sectional shape. Therefore, since the member portions are combined to have the closed cross-sectional shape as a whole, it is possible to ensure the same rigidity as the skeletal member having the closed cross-sectional shape with one part. In addition, since one member portion and the other member portion can be disposed separately from each other, it is possible to improve the degree of freedom in disposition, and space saving can be achieved. Therefore, in the suspension member according to the first aspect of the present disclosure, it is possible to ensure rigidity and achieve space saving.

In the suspension member according to the first aspect of the present disclosure, the member portions may be cross member portions extending in a vehicle width direction, and one of the member portions may be disposed behind a drive unit in a vehicle front-rear direction to be close to a lower portion of a drive unit with an upper side of in a vehicle up-down direction and a front side in the vehicle front-rear direction as an opening direction, and the other of the member portions may be disposed in front of vehicle equipment with a lower side in the vehicle up-down direction and a rear side in the vehicle front-rear direction as an opening direction.

In the suspension member according to the first aspect of the present disclosure, in a case where the vehicle equipment moves toward the front of the vehicle at the time of a rear-end collision, since the vehicle equipment is movable within the open cross-section of the other member portion, it is possible to take a sufficient stroke.

In the suspension member according to the first aspect of the present disclosure, the skeletal member including the member portions may be integrally molded by casting.

In the suspension member according to the first aspect of the present disclosure, since the skeletal member including the member portions is integrally molded by casting, it is possible to further improve the rigidity.

As described above, with the suspension member according to the present disclosure, it is possible to ensure rigidity and achieve space saving.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a plan view schematically showing a suspension member and the like according to an embodiment of the present disclosure;

FIG. 2 is a side view schematically showing a suspension member and the like according to an embodiment of the present disclosure;

FIG. 3 is a cross-sectional perspective view schematically showing an example of a cross-section taken along the line III-III of FIG. 1;

FIG. 4 is a side view schematically showing the disposition of each part near the suspension member; and

FIG. 5 is a cross-sectional view for describing the effect of a pair of member portions.

### DETAILED DESCRIPTION OF EMBODIMENTS

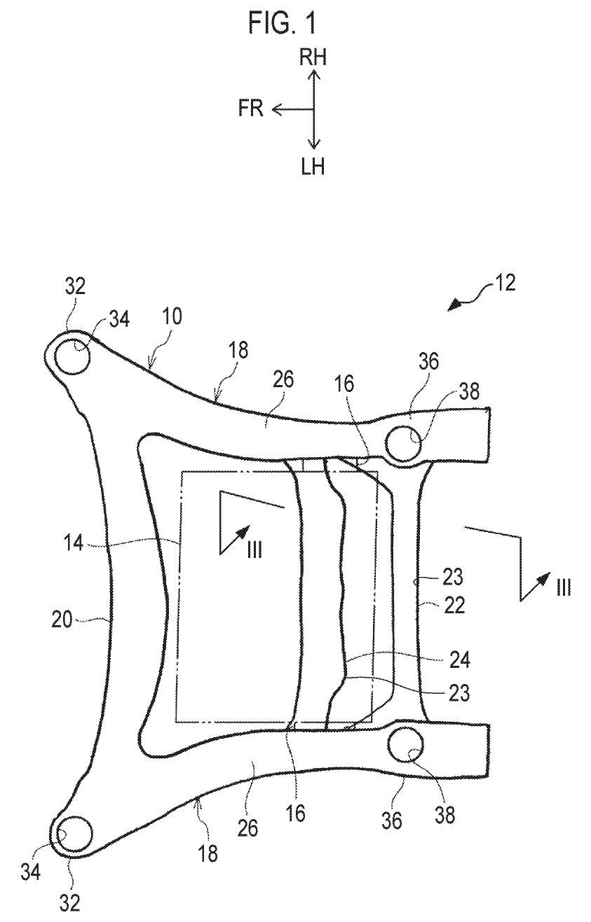

Hereinafter, a suspension member 10 according to an embodiment of the present disclosure will be described with reference to FIGS. 1 to 5. In the present specification and the drawings, the same reference numerals are given to components having substantially the same functional configuration, and the description thereof will be omitted. In addition, an arrow FR shown as appropriate in each drawing indicates a front side in the vehicle front-rear direction, and an arrow UP indicates an upper side in the vehicle up-down direction. In addition, an arrow LH indicates a left side in a vehicle width direction (right-left direction), and an arrow RH indicates a right side in the vehicle width direction (right-left direction). Hereinafter, when the front-rear, the up-down, and the right-left directions are simply described, the vehicle front-rear direction, the vehicle up-down direction, and the right-left direction (vehicle width direction) of the vehicle are represented unless otherwise specified.

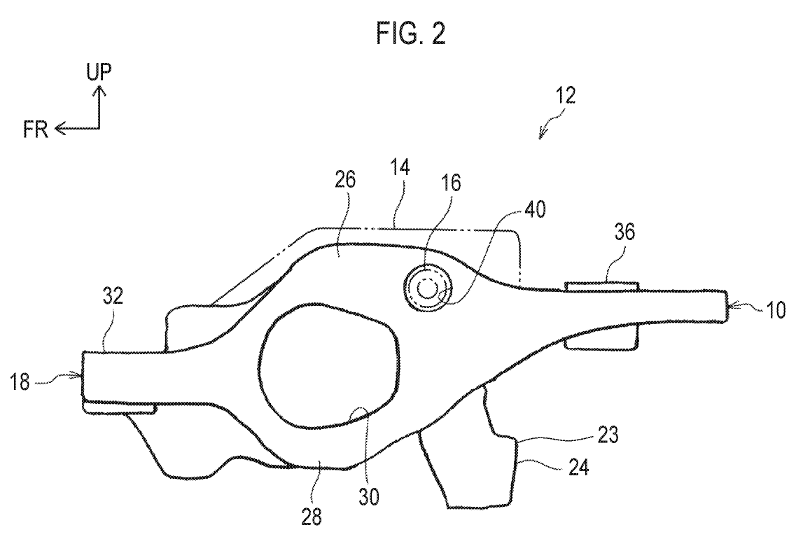

As shown in FIGS. 1 and 2, the suspension member 10 of the present embodiment is provided at a rear portion of a vehicle 12 as an example. Various arms (not shown) that support right and left rear wheels are attached to the suspension member 10. In FIGS. 1 and 2, the portion of the suspension member 10 to which various arms are attached is not shown. In addition, in the suspension member 10, the motor 14 is supported by the motor mount 16 to drive right and left rear wheels. The motor mount 16 is attached to a motor mount attachment hole 40 (see FIG. 2) provided in an upper intermediate member portion 26 described below and penetrating in the vehicle width direction.

The suspension member 10 is provided by, as an example, aluminum die casting, and each of the parts described below is integrally molded by casting. The suspension member 10 includes, as an example, right and left side member portions 18 extending in the front-rear direction on both sides in the vehicle width direction, a front cross member portion 20 and a rear cross member portion 22 that connect a front end portion and a rear end portion of the right and left side member portions 18 to each other in the right-left direction, and an intermediate cross member portion 24 that connects an intermediate portion of the right and left side member portions 18 in the front-rear direction to each other in the right-left direction. In the present embodiment, the rear cross member portion 22 and the intermediate cross member portion 24 constitute the member portions 23. The member portions 23 will be described in detail later.

As shown in FIG. 1, the range from the center portion of the right and left side member portions 18 in the front-rear direction to the front end portion has a shape that is gently curved toward the outside in the vehicle width direction as viewed from the upper side as the front side is approached. As shown in FIG. 2, the intermediate portion of the right and left side member portions 18 in the front-rear direction includes an upper intermediate member portion 26 extending in the front-rear direction and a lower intermediate member portion 28 extending in the front-rear direction below the upper intermediate member portion 26. An opening 30 through which a drive shaft that transmits the rotation of the motor 14 to the rear wheels is inserted in the right-left direction is provided between the upper intermediate member portion 26 and the lower intermediate member portion 28.

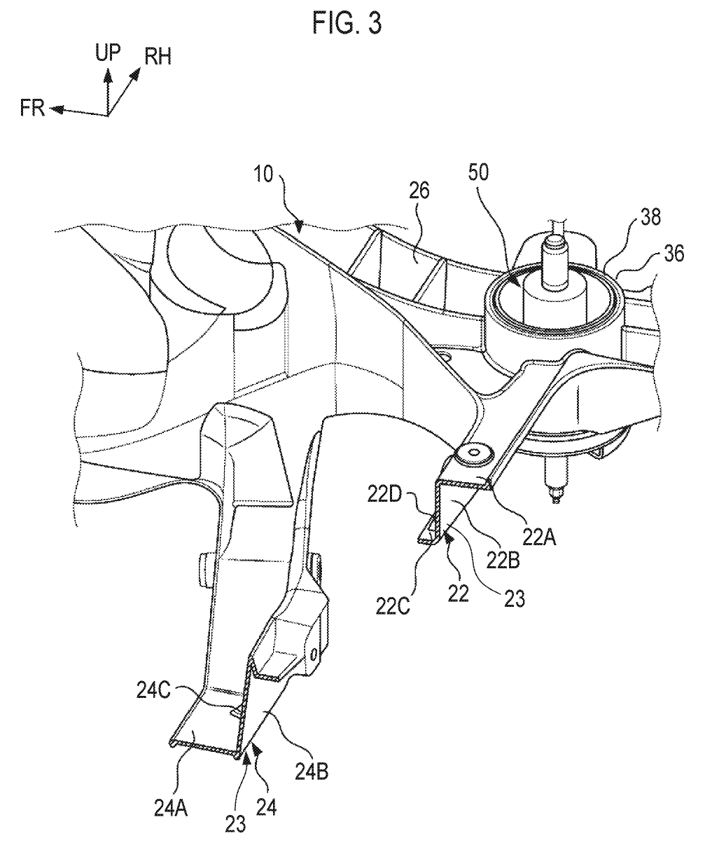

As shown in FIGS. 1 and 2, a front mount attachment portion 32 that is fixed to a vehicle body (not shown) is provided at a front end portion of each of the right and left side member portions 18. The front mount attachment hole 34 to which the body mount portion 50 (see FIG. 3) is attached by press-fitting is provided in the front mount attachment portion 32. Then, the body mount portion 50 attached to the front mount attachment hole 34 is fixed to the vehicle body, so that the front mount attachment portion 32 is fixed to the vehicle body.

In addition, a rear mount attachment portion 36 fixed to a vehicle body (not shown) is provided at a rear end portion of the right and left side member portions 18. A rear mount attachment hole 38 to which a body mount portion 50 (see FIG. 3) is attached by press-fitting is provided in the rear mount attachment portion 36. Then, the body mount portion 50 attached to the rear mount attachment hole 38 is fixed to the vehicle body, so that the rear mount attachment portion 36 is fixed to the vehicle body.

As shown in FIG. 1, as an example, the front cross member portion 20 has a shape that is gently curved rearward toward the center portion in the vehicle width direction in a plan view, for example, and is provided between the front mount attachment portions 32 of the right and left side member portions 18. In addition, as an example, the rear cross member portion 22 is provided between the rear mount attachment portions 36 of the right and left side member portions 18. Further, as shown in FIGS. 1 and 2, the intermediate cross member portion 24 is provided between rear end portions of the lower intermediate member portion 28 of the right and left side member portions 18.

Next, the member portions 23 will be described. As shown in FIGS. 1 and 3, the member portions 23, that is, the rear cross member portion 22 and the intermediate cross member portion 24 extend in the vehicle width direction, and each has a substantially L-shaped open cross-sectional shape. Here, the “substantially L-shaped” is not limited to a shape in which the two pieces are necessarily perpendicular to each other, and it is sufficient that the two pieces extend in different directions. In addition, as long as the core is mainly composed of two pieces, for example, the core may further have other structures, such as a flange or a rib.

As shown in FIG. 3, the intermediate cross member portion 24 of one of the member portions 23 includes a lower wall 24A and a rear wall 24B erected upward from a rear end of the lower wall 24A. That is, the intermediate cross member portion 24 has the vehicle upper side and the vehicle front side as the opening direction. Further, as an example, a rib 24C that connects the lower wall 24A and the rear wall 24B is provided in a front corner portion between the lower wall 24A and the rear wall 24B. The ribs 24C are provided at predetermined intervals in the vehicle width direction, as an example.

In addition, the other rear cross member portion 22 in the member portions 23 includes an upper wall 22A and a front wall 22B that is erected downward from a front end of the upper wall 22A. That is, the rear cross member portion 22 has the vehicle lower side and the vehicle rear side as the opening direction. In addition, the rear cross member portion 22 includes a flange 22C that extends forward from a lower end of the front wall 22B, as an example. Further, as an example, a rib 22D that connects the front wall 22B and the flange 22C is provided in a front corner portion between the front wall 22B and the flange 22C. The ribs 22D are provided at predetermined intervals in the vehicle width direction, as an example.

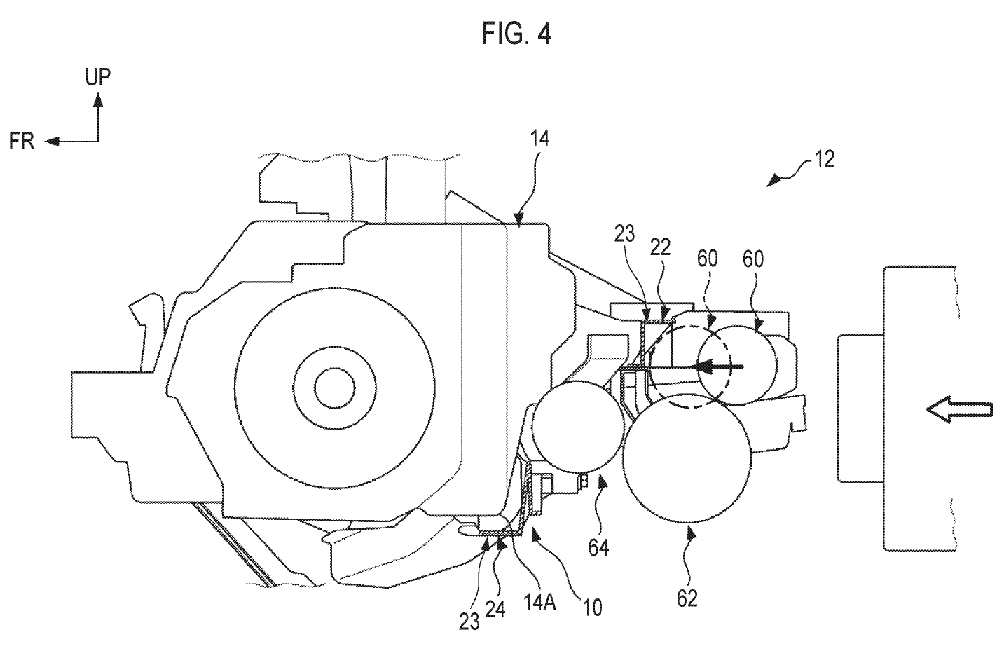

Next, the disposition of each part near the suspension member 10 will be described. As shown in FIG. 4, the intermediate cross member portion 24 is disposed close to the lower portion 14A of the vehicle rear portion of the motor 14 as the drive unit in a side view. Specifically, as shown in FIG. 4, as an example, at least a part of the lower portion 14A of the motor 14 is disposed so as to be positioned in the open cross-section of the intermediate cross member portion 24. In other words, the intermediate cross member portion 24 is disposed to overlap at least a part of the lower portion 14A of the motor 14 in the vehicle front-rear direction. The motor 14 is disposed with a gap between an upper surface of the lower wall 24A and a front surface of the rear wall 24B of the intermediate cross member portion 24 and the lower portion 14A of the motor 14.

In addition, the rear cross member portion 22 is disposed on a front side of at least a part of the active stabilizer device 60 as the vehicle equipment in a side view. In other words, the rear cross member portion 22 is disposed at a position overlapping at least a part of the active stabilizer device 60 in the vehicle front-rear direction. Specifically, as shown in FIG. 4, as an example, the active stabilizer device 60 is disposed so as to be positioned on the vehicle front side away from inside of the open cross-section of the rear cross member portion 22, in a side view.

Further, as shown in FIG. 4, as an example, an air suspension tank 62 is disposed diagonally forward and below the active stabilizer device 60 in side view. In addition, dynamic rear steering (DRS) 64 that steers rear wheels (not shown) is disposed in front of the air suspension tank 62 in a side view. The DRS 64 is disposed behind the intermediate cross member portion 24 and behind the rear portion of the motor 14 in a side view.

### Action and Effect

Next, the effects of the present embodiment will be described.

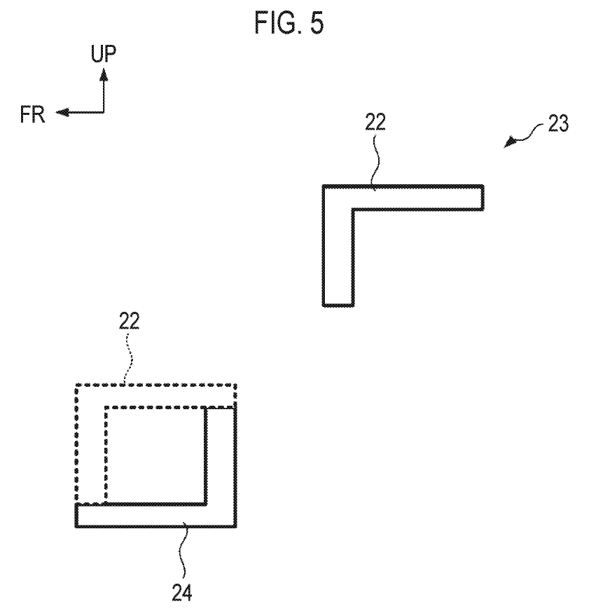

In the suspension member 10 according to the present embodiment, the member portions 23 are disposed to be combined with each other to define a substantially L-shaped open cross-sectional shape in which the closed cross-sectional shapes face each other in one direction, that is, in the vehicle width direction. Specifically, as shown in FIGS. 4 and 5, when viewed from the vehicle width direction, the intermediate cross member portion 24 and the rear cross member portion 22 are disposed at separated positions in the vehicle up-down direction and the vehicle front-rear direction.

The intermediate cross member portion 24 and the rear cross member portion 22 are disposed such that the substantially L-shaped open cross-section is disposed in two directions orthogonal to each other, that is, the vehicle up-down direction and the vehicle front-rear direction, in an inverted direction. Specifically, while the intermediate cross member portion 24 has the vehicle upper side and the vehicle front side as the opening direction, the rear cross member portion 22 has the vehicle lower side and the vehicle rear side as the opening direction.

Therefore, as shown in the lower view of FIG. 5, as an example, the rear cross member portion 22 is combined with the intermediate cross member portion 24 such that the substantially L-shaped open cross-sectional shapes of the rear cross member portion 22 and the intermediate cross member portion 24 face each other to define a closed cross-sectional shape. As described above, since the member portions 23 are combined to have the closed cross-sectional shape as a whole, it is possible to ensure the same rigidity as the skeletal member having the closed cross-sectional shape with one part by the member portions 23.

Further, as shown in FIG. 5, the member portions 23 can be disposed separately from the intermediate cross member portion 24 and the rear cross member portion 22, so that the degree of freedom in disposition can be improved, and the space saving can be achieved. That is, as an example, at least a part of the lower portion 14A of the motor 14 can be disposed in the open cross-section of the intermediate cross member portion 24, so that unnecessary space can be reduced as compared with the cross member portion having a closed cross-sectional shape.

Therefore, in the suspension member 10 according to the present embodiment, it is possible to ensure rigidity and achieve space saving.

In the suspension member 10 according to the present embodiment, as shown in FIG. 4, the rear cross member portion 22 has the vehicle lower side and the vehicle rear side as the opening direction, and on the front side of at least a part of the active stabilizer device 60 as the vehicle equipment in a side view. Therefore, in a case where the active stabilizer device 60 moves toward the front of the vehicle as shown by a broken line in FIG. 4 at the time of the rear collision, at least a part of the active stabilizer device 60 can be moved into the open cross-section of the rear cross member portion 22. Therefore, it is possible to take a sufficient stroke with respect to the active stabilizer device 60.

In the suspension member 10 according to the present embodiment, the skeletal member including the member portions 23 is integrally molded by casting, so that the rigidity can be further improved.

### Supplementary Note

In the embodiment described above, the intermediate cross member portion 24 and the rear cross member portion 22 are provided with the ribs 24C, 22D, respectively, but may not be provided with the ribs 24C, 22D. The intermediate cross member portion 24 and the rear cross member portion 22 include ribs 24C, 22D intermittently provided in the vehicle width direction, but may include, for example, one rib extending in the vehicle width direction.

In the embodiment described above, the member portions 23 is constituted by the intermediate cross member portion 24 and the rear cross member portion 22 that are provided to be separated from each other in the vehicle front-rear direction, but the present disclosure is not limited thereto. For example, the member portions may be constituted of two member portions provided to be separated from each other in the vehicle width direction.

In the embodiment described above, the member portions 23 is the skeletal member that constitutes the suspension member 10, but for example, the member portions 23 of the present disclosure may be applied to a skeletal member that constitutes a skeletal structure of a vehicle.

In addition, the configuration of the present disclosure is not limited to the embodiment described above, and the configuration can be appropriately changed as long as the problems can be solved.

What is claimed is:

1. A suspension member comprising a pair of member portions, the member portions constituting a part of a skeletal member and each having a substantially L-shaped open cross-sectional shape, wherein the member portions are disposed such that, as viewed in one direction, the substantially L-shaped open cross-sectional shapes, when the member portions are taken in combination, face each other and define a closed cross-sectional shape.

2. The suspension member according to claim 1, wherein:
the member portions are cross member portions extending in a vehicle width direction; and
one of the member portions is disposed behind a drive unit in a vehicle front-rear direction to be close to a lower portion of the drive unit with an upper side in a vehicle up-down direction and a front side in the vehicle front-rear direction as an opening direction, and the other of the member portions is disposed in front of vehicle equipment with a lower side in the vehicle up-down direction and a rear side in the vehicle front-rear direction as an opening direction.

3. The suspension member according to claim 1, wherein the skeletal member including the member portions is integrally molded by casting.
